(19) United States
(12) Patent Application Publication
(10) Pub. No.: US 2008/0015804 A1
(43) Pub. Date: Jan. 17, 2008

(54) Method and apparatus for compensating for alignment mismatch of optical modulator

(76) Inventors: Aron Baik, Yongin-si (KR); Youson Bang, Seoul (KR); Du-sik Park, Suwon-si (KR)

Correspondence Address: STAAS & HALSEY LLP, SUITE 700, 1201 NEW YORK AVENUE, N.W., WASHINGTON, DC, 20005, US

(21) Appl. No.: 11/812,524

(22) Filed: Jun. 19, 2007

(30) Foreign Application Priority Data
Jun. 19, 2006 (KR) 10-2006-0055027

(51) Int. Cl. G01D 18/00

(52) U.S. Cl. 702/86

(57) ABSTRACT

Provided is a method and apparatus for compensating for a misalignment of an optical modulator. The method includes performing gamma correction on an input signal having M gradation levels and outputting a preprocessed signal; performing a linearization transform on the preprocessed signal, performing a uniformity transform on the linearly transformed signal to limit a region of the linearly transformed signal, and outputting a compensated signal; and receiving the output compensated signal using the optical modulator and outputting a compensated luminance value.

### CROSS-REFERENCE TO RELATED APPLICATIONS

This application claims priority from Korean Patent Application No. 10-2006-0055027, filed on Jun. 19, 2006 in the Korean Intellectual Property Office, the disclosure of which is incorporated herein by reference in its entirety.

### BACKGROUND OF THE INVENTION

1. Field of the Invention

The present invention relates to a method and apparatus for compensating for an alignment mismatch of an optical modulator, and more particularly, to a method and apparatus for compensating for the alignment mismatch of an optical modulator, the method and apparatus preprocessing and compensating an input signal and then inputting the preprocessed and compensated signal to an optical modulator in order to generate a lookup table for compensating for line pattern artifacts of an image, which are caused by the alignment mismatch of gratings that constitute the optical modulator, and thus enhancing image quality.

2. Description of the Related Art

Unlike conventional digital information processing which cannot deal with a large amount of data and cannot be performed in real time, optical signal processing can be performed at high speed and in parallel, and can deal with a large amount of data. Accordingly, there have been studies on the design and manufacture of binary phase filters based on a spatial optical modulation theory, optical logic gates, optical amplifiers, image processing techniques, optical devices, optical modulators, and the like. Optical modulators are utilized in the fields of optical memories, optical displays, printers, optical interconnection, and holograms. In addition, optical beam scanning apparatuses using these optical modulators are being researched and developed.

An optical beam scanning apparatus included in an image forming apparatus, such as a laser printer, a light emitting diode (LED) printer, and an electrophotographic copier, scans a light beam, spots the scanned light beam onto a scanned object, and forms an image. With the development of projection televisions (TVs), optical beam scanning apparatuses have been used to project a beam onto a scanned object.

Optical beam scanning apparatuses use one-dimensional (1D) optical modulators that display images using light diffraction. However, even a very slight alignment mismatch of optical devices, which may occur while an optical modulator is manufactured and processed, hinders the optical modulator from having ideal luminance characteristics. As a result, horizontal line pattern artifacts are generated in a scanned image.

### SUMMARY OF THE INVENTION

Accordingly, it is an aspect of the present invention to provide a compensation method and apparatus which can reduce line pattern artifacts and thus enhance image quality by preprocessing and compensating an input signal and then inputting the preprocessed and compensated signal to an optical modulator.

Additional aspects and/or advantages of the invention will be set forth in part in the description which follows and, in part, will be apparent from the description, or may be learned by practice of the invention.

The foregoing and/or other aspects are achieved by providing a method of compensating for an alignment mismatch of an optical modulator. The method includes performing gamma correction on an input signal having M gradation levels and outputting a preprocessed signal according to the gamma correction; performing a linearization transform on the preprocessed signal, performing a uniformity transform on the linearly transformed signal to limit a region of the linearly transformed signal, and outputting a compensated signal; and receiving the output compensated signal using an optical modulator and outputting a compensated luminance value according to the received signal.

The foregoing and/or other aspects are also achieved by providing an apparatus for compensating for an alignment mismatch of an optical modulator. The apparatus includes a preprocessed signal output unit performing gamma correction on an input signal having M gradation levels and outputting a preprocessed signal according to the gamma correction; a compensated signal output unit performing a linearization transform on the preprocessed signal, performing a uniformity transform on the linearly transformed signal to limit a region of the linearly transformed signal, and outputting a compensated signal; and a luminance value output unit receiving the output compensated signal using an optical modulator and outputting a compensated luminance value according to the received signal.

### BRIEF DESCRIPTION OF THE DRAWINGS

The patent or application file contains at least one drawing executed in color. Copies of this patent or patent application publication with the color drawings will be provided by the Office upon request and payment of the necessary fee. These and/or other aspects and advantages of the invention will become apparent and more readily appreciated from the following description of the embodiments, taken in conjunction with the accompanying drawings of which:

FIG. 1 is a diagram illustrating the configuration of a display system using an optical modulator according to an embodiment of the present invention;

FIG. 2 is a diagram for explaining a method of compensating for an alignment mismatch of an optical modulator according to an embodiment of the present invention;

FIG. 3 is a flowchart illustrating a method of compensating for the alignment mismatch of an optical modulator according to an embodiment of the present invention;

FIG. 4 is a diagram illustrating the entire configuration of an apparatus for compensating for the alignment mismatch of an optical modulator according to an embodiment of the present invention;

FIG. 5 is a graph illustrating a linearization transform process according to an embodiment of the present invention;

FIG. 6 is a graph illustrating a uniformity transform process according to an embodiment of the present invention;

FIGS. 7A and 7B are graphs illustrating a uniformity transform process according to an embodiment of the present invention;

FIG. 8 is a graph illustrating the relationship between a preprocessed signal and a compensated signal according to an embodiment of the present invention; and

FIGS. 9A and 9B are views for comparing an output image before and after a compensation method according to an embodiment of the present invention is applied.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

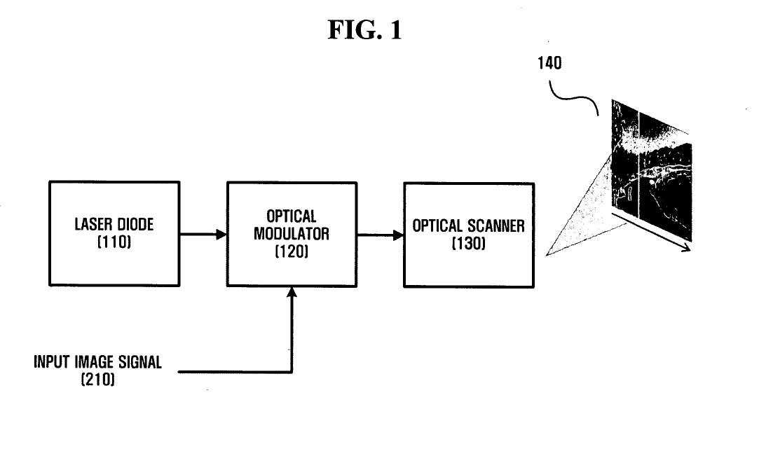

FIG. 1 is a diagram illustrating the configuration of a display system using an optical modulator according to an embodiment of the present invention.

Referring to FIG.1, the display system includes a laser diode 110, an optical modulator 120, an optical scanner 130, and a scanned apparatus 140.

The laser diode 110 is a device widely used in the fields of optical communication, optical memory, and optical information processing. The laser diode 110, which includes a p-n junction, excites a region near the p-n junction and emits a laser. The laser emitted from the laser diode 110 is input to the optical modulator 120. The optical modulator 120 adds an input image signal to the laser using diffraction characteristics of light and modulates the laser having the input image signal. The optical scanner 130 projects an image signal received from the optical modulator 120 onto the scanned apparatus 140. The optical scanner 130 continuously scans each vertical line of the scanned apparatus 140 at a time from left to right and thus forms a picture frame.

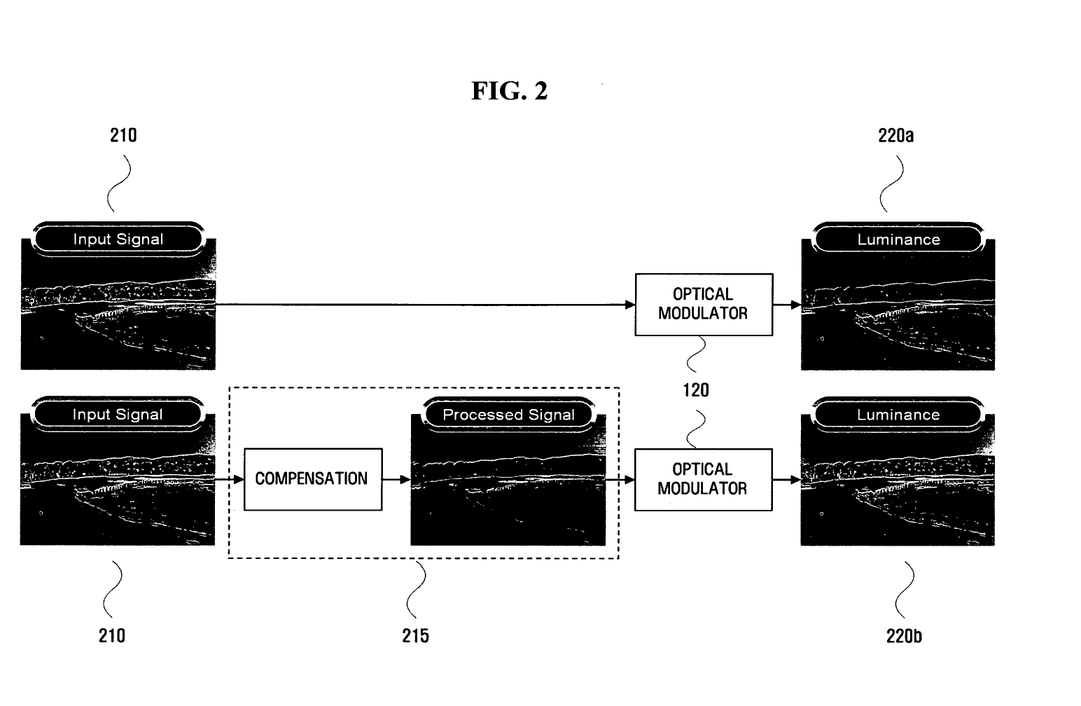

Each of gratings that constitute a one-dimensional (1D) array of the optical modulator 120 corresponds to one horizontal line of the picture frame. If there is an alignment mismatch between the gratings of the 1D array, horizontal line pattern artifacts may be generated in the picture frame scanned onto the scanned apparatus 140. The whole concept of a method of compensating for the alignment mismatch of an optical modulator to prevent such line pattern artifacts according to an embodiment of the present invention will now be described with reference to FIG. 2.

In the upper part of FIG. 2, a conventional process of outputting an image signal is illustrated. In this conventional process, an optical modulator 120 receives an input signal 210 and generates an output image 220a having a particular luminance value. If the compensation method according to an embodiment of the present invention is applied to this conventional process, as illustrated in the lower part of FIG. 2, an input signal 210 is processed by a compensation apparatus 215 according to an embodiment of the present invention. Then, an optical modulator 120 receives the processed input signal 210 and generates an output image 220b. The output image 220b may have reduced line pattern artifacts and thus an improved quality compared with the output image 220a generated according to the conventional process.

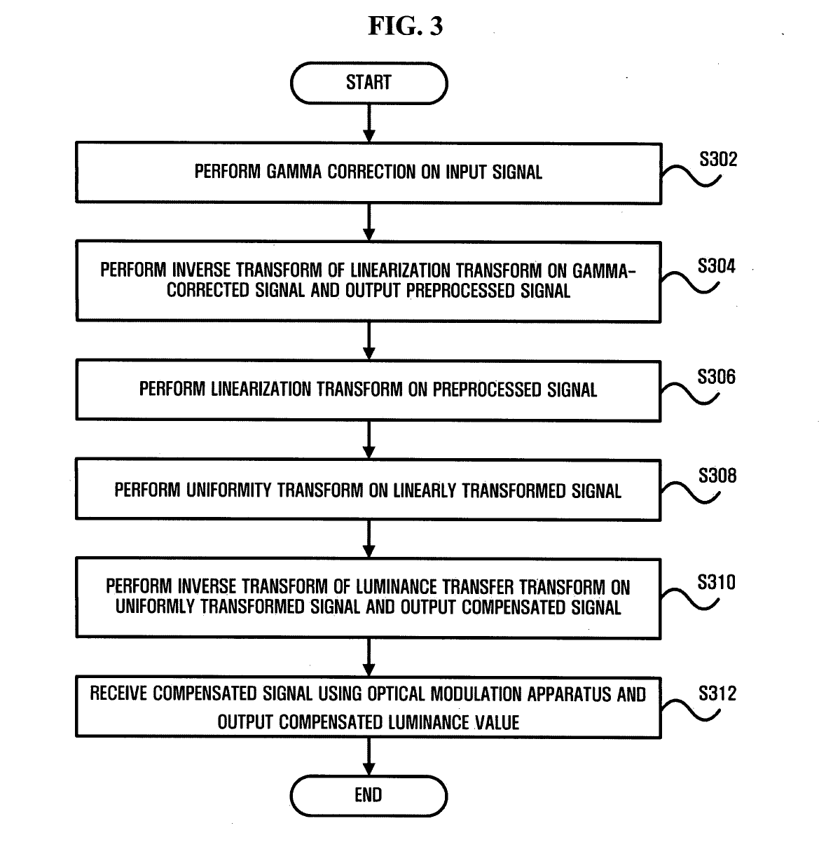

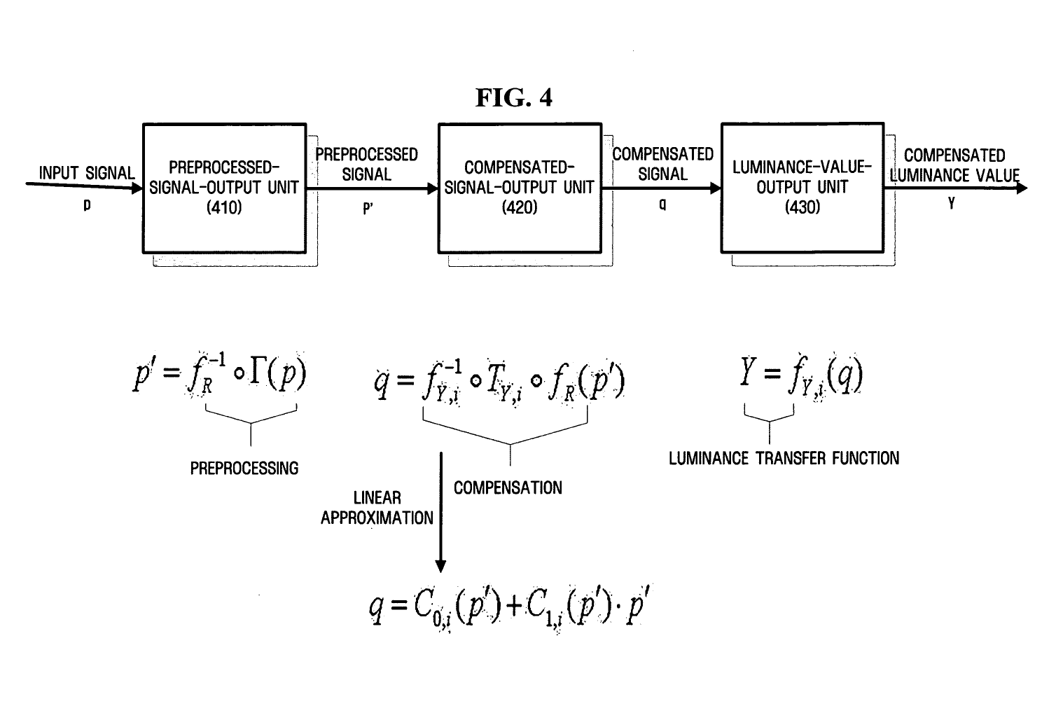

FIG. 3 is a flowchart illustrating a method of compensating for the alignment mismatch of an optical modulator according to an embodiment of the present invention. FIG. 4 is a diagram illustrating the entire configuration of an apparatus for compensating for the alignment mismatch of an optical modulator according to an embodiment of the present invention.

First, a preprocessed signal output unit 410 receives an input signal p and performs gamma correction on the input signal p (operation S302). The input signal p has M gradation levels. In the present embodiment, since it is assumed that the input signal p is an 8-bit signal for convenience of description, the M gradation levels representing a range of the highest density to the lowest density of an input image may be 256. A gamma is a numerical representation of a ratio of an output signal to an input signal. For example, if there is an equal ratio of input and output signals, the gamma value is 1. Therefore, gamma correction refers to a process in which the gamma value of the input signal p is adjusted to correct gradation characteristics. In FIG. 4, the gamma-corrected input signal is indicated by (p) in the form of a function.

Next, the preprocessed signal output unit 410 performs an inverse transform f_{R}⁻¹ of a linearization transform on the gamma-corrected signal (p) and outputs a preprocessed signal p′ (operation S304). The preprocessed signal p′ may be defined by Equation (1).
p′=fᵣ⁻¹∘Γ(p) (1)
where p indicates an input signal, and p′ indicates a preprocessed signal output from the preprocessed signal output unit 410. The preprocessed signal p′ output using Equation (1) is stored in the form of an M×1 lookup table. Since it is assumed that M is 256 in the present embodiment, the preprocessed signal p′ may be stored in the form of a 256×1 lookup table.

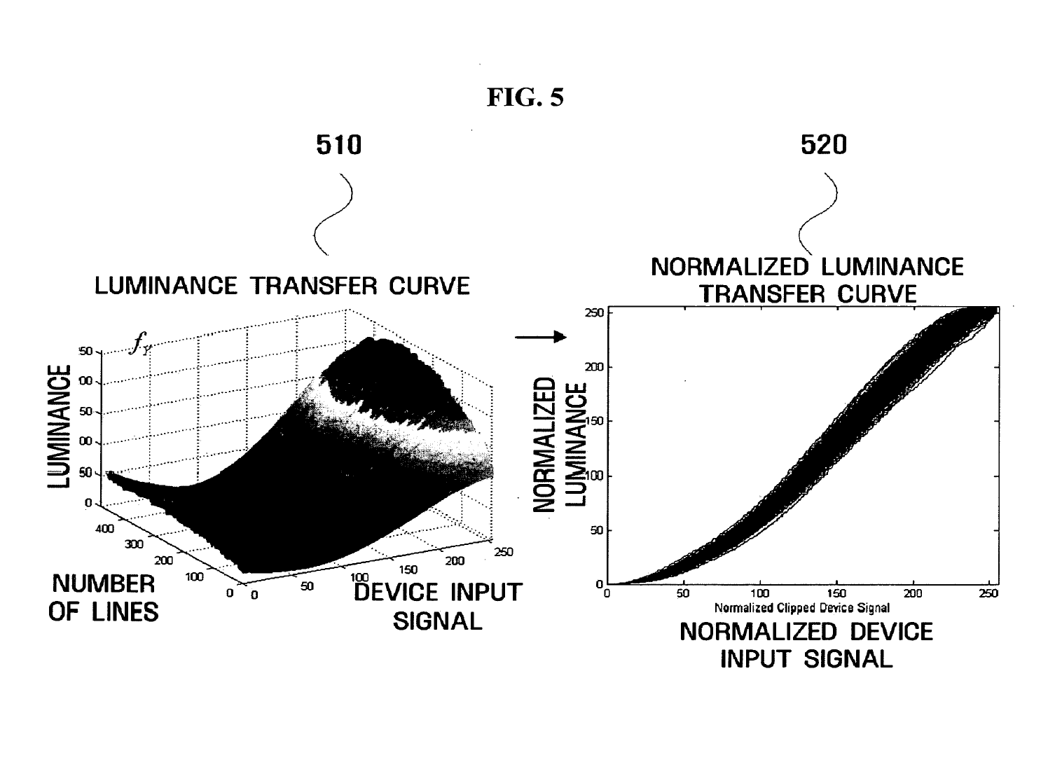

Then, a compensated signal output unit 420 performs a compensation process on the preprocessed signal p′. As part of the compensation process, the compensated signal output unit 420 first performs the linearization transform on the preprocessed signal p′ (operation S306). The linearization transform process will now be described with reference to FIG. 5. FIG. 5 is a graph illustrating a linearization transform process according to an embodiment of the present invention.

A graph 510 on the left of FIG. 5 illustrates a luminance transfer curve f_{Y}. A horizontal axis of the graph 510 indicates a value of a device input signal input to an optical modulator, a vertical axis indicates the number of lines corresponding to the number of vertical pixels of an image, and a height axis indicates an output luminance value. A graph 520 in the middle of FIG. 5 illustrates a normalized luminance transfer curve. The graph 520 is a two-dimensional (2D) representation of the graph 510 having the horizontal and height axes normalized. A graph 530 on the right of FIG. 5 illustrates a linear transformation curve and represents a normalized function using the graph 520. In other words, the graph 520 illustrates a linear transformation function f_{R} in which the relationship between an input and an output is close to a linear function. This linearization transform process precedes a uniformity transform process to enhance the accuracy of the uniformity transform process performed on each line, which will be described later.

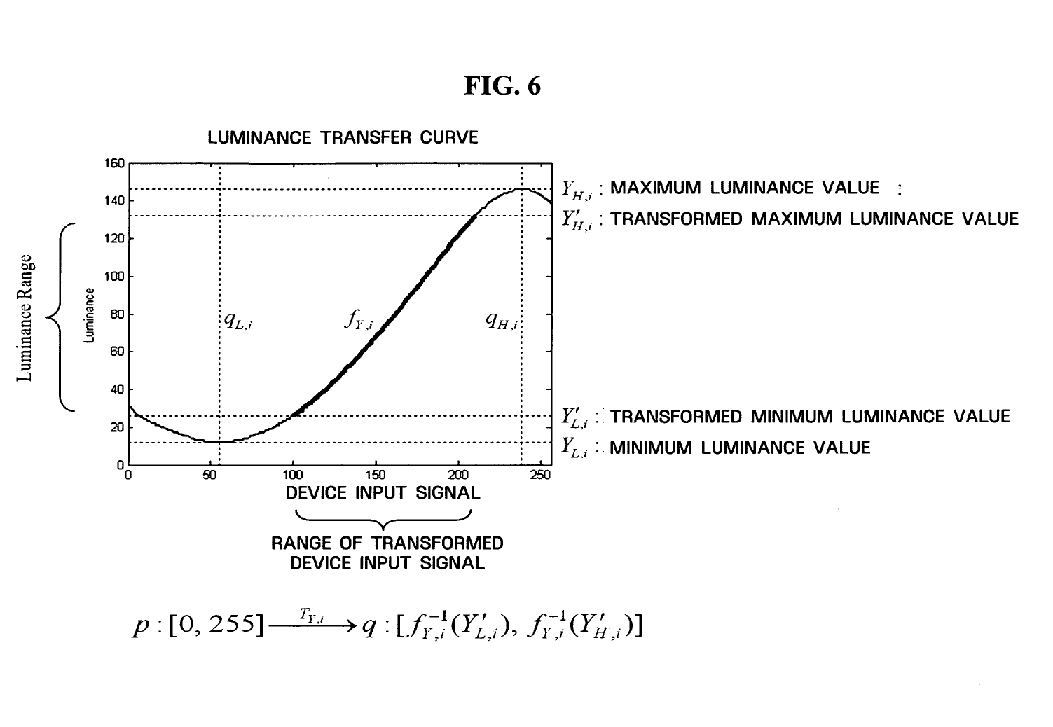

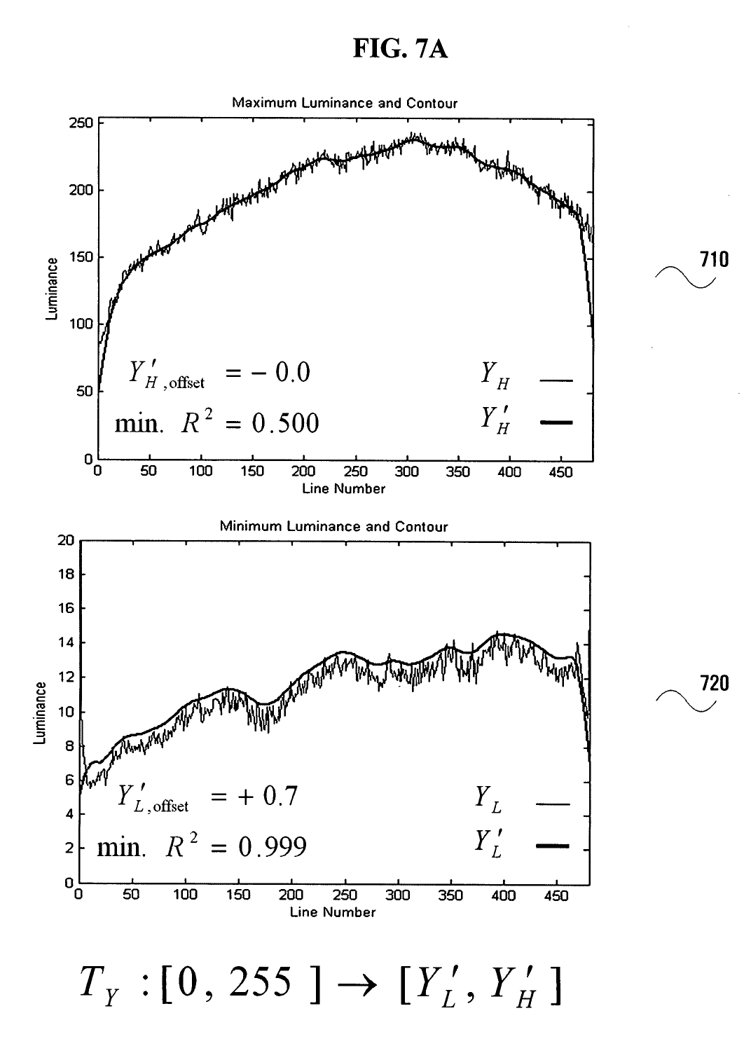

Next, the compensated signal output unit 420 performs a uniformity transform T_{Y} on the linearly transformed signal (operation S308). The uniformity transform T_{Y} will now be described with reference to FIGS. 6, 7A and 7B.

FIG. 6 is a graph illustrating a uniformity transform process according to an embodiment of the present invention. A horizontal axis of a luminance transfer curve f_{Y} illustrated in FIG. 6 indicates 256 gradation levels of an 8-bit device input signal, and a vertical axis indicates a luminance value range of 0 to 160. In this graph, Y_{H,i} indicates a maximum luminance value and Y_{L,i} indicates a minimum luminance value. In addition, Y′_{H,i} indicates a maximum luminance value after the uniformity transform process and Y′_{L,i} indicates a minimum luminance value after the uniformity transform process. Also, q_{H,i} indicates a device input value at the maximum luminance value Y_{H,i}, and q_{L,i} indicates a device input value at the minimum luminance value Y_{L,i}.

Referring to the luminance transfer curve f_{Y}, the device input signal weakly decreases between 0 and q_{L,i}, then linearly increases between q_{L,i} and q_{H,i}, and slowly decreases between q_{H,i} and 255. If a gradation value of the device input signal increases, the output luminance value must be linearly increased. Therefore, an ideal form of the luminance transfer curve f_{Y} is a linear function which increases linearly. For this reason, the uniformity transform process is performed to limit a gradation region of the device input signal, which extends from 0 to 255, to a gradation region which extends from q_{L,i} to q_{H,i} and in which the luminance transfer curve f_{Y} increases linearly. In FIG. 6, the gradation level range [0, 255] of the device input signal is changed to a range [f_{Y,i}⁻¹(Y_{L,i}′), f_{Y,i}′(Y_{H,i}′)] after the uniformity transform T_{Y}.

FIGS. 7A and 7B are graphs illustrating a uniformity transform process according to another embodiment of the present invention. A graph 710 in the upper part of FIG. 7A illustrates a maximum luminance value and contour of each line, and a graph 720 in the lower part of FIG. 7B illustrates a minimum luminance value and contour of each line. A horizontal axis of each of the two graphs 710 and 720 indicates an index of each line (a total of 480 lines in the present embodiment) having a limited gradation region after the uniformity transform of FIG. 6. In addition, a vertical axis indicates a luminance value for each line index. As each line index increases, the maximum luminance value and the minimum luminance value change unevenly. To render the contour of curves in the graphs 710 and 720 smooth, a fitting process must be performed.

In the graph 710, to form a smooth contour, min.R² is set to 0.5 and an offset of −0 is assigned for a change in the maximum luminance value Y_{H} of each line. In the graph 720, to form a smooth contour, min.R² is set to 0.999 and an offset of +0.7 is assigned for a change in the minimum luminance value Y_{L} of each line. In other words, the uniformity transform process including the fitting process illustrated in FIG. 7A is designed to change the luminance level range [0, 255] of the device input signal into a range [Y′_{L}, Y′_{H}].

Assigning an offset as illustrated in FIG. 7A is to prevent line pattern artifacts in regions near the maximum and minimum luminance values due to clipping. Referring to FIG. 7B, a picture 730 on the left is before the fitting process, and a picture 740 on the right is after the fitting process. The picture 740 has reduced line pattern artifacts in regions near the minimum and maximum luminance values.

The uniformity transform process illustrated in FIGS. 6, 7A and 7B must be performed on each line. Therefore, if the number of vertical pixels of an input image is 480, the uniformity transform process must be performed on each of 480 lines.

The compensated signal output unit 420 performs an inverse transform f_{Y}⁻¹ of the luminance transfer transform on the uniformly transformed signal and outputs a compensated signal q (operation S310). The compensated signal q may be defined by Equation (2).
q=f_{Y,i}⁻¹∘T_{Y,i}∘f_{R}(p′) (2)

In Equation (2), if p′ indicates the preprocessed signal and q indicates the compensated signal, f_{Y,i}⁻¹ indicates an inverse transform of the luminance transfer transform, T_{Y,i} indicates a uniformity transform illustrated in FIGS. 6, 7A and 7B, f_{R} indicates the linearization transform, and i indicates a line index corresponding to the number of pixels of vertical resolution of the input signal.

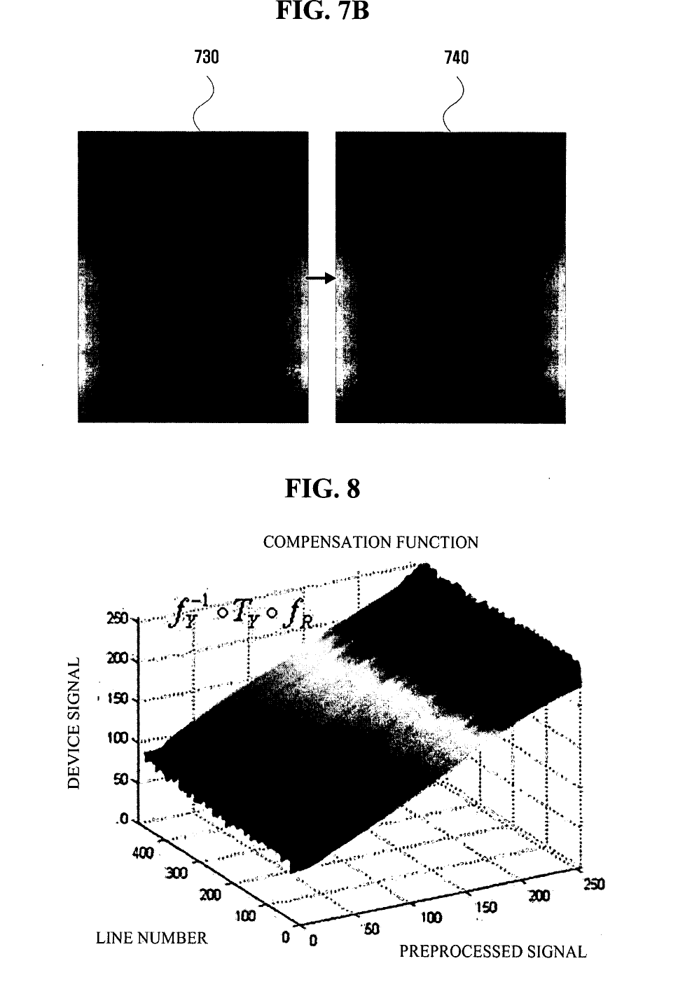

The result of the inverse transform using Equation (2) will now be described with reference to FIG. 8. In a graph illustrated in FIG. 8, the relationship between the preprocessed signal p′ and the device input signal q is represented for each line index N. Referring to the graph, for all of 480 lines, as the preprocessed signal p′ increases, the device input signal q is linearly increased.

The relationship between the preprocessed signal p′ input for the compensation process and the compensated signal q output as a result of the compensation process may be stored in the form of an N×P lookup table. N indicates the number of lines (480) in the luminance transfer curve, and P indicates the number of parameters (32) for the compensated signal.

The relationship between the preprocessed signal p′ and the compensated signal q may be linearly approximated using Equation (3).
q=C_{0,i}(p′)+C_{1,i}(p′)·p′ (3)
where C_{0,i} and C_{1,i} respectively indicate linear approximation parameters, and the relationship between the preprocessed signal p′ and the compensated signal q shows a linear function.

Finally, the luminance value output unit 430 receives the output compensated signal q through an optical modulator and outputs a compensated luminance value V (operation S312). In other words, the luminance value output unit 430 performs the luminance transfer transform f_{Y,i} on the output compensated signal q and outputs the compensated luminance value Y using the optical modulator. The compensated luminance value Y may be defined by Equation (4).
Y=f_{Y,i}(q) (4).

If q of Equation (2) and p′ of Equation (1) are substituted for q of Equation (4), Equation (4) may be rearranged into Equation (5).
Y=T_{Y,i}∘Γ(p) (5)

In other words, if the uniformity transform T_{Y} is performed on the gamma-corrected signal (p), the compensated luminance value Y can be obtained.

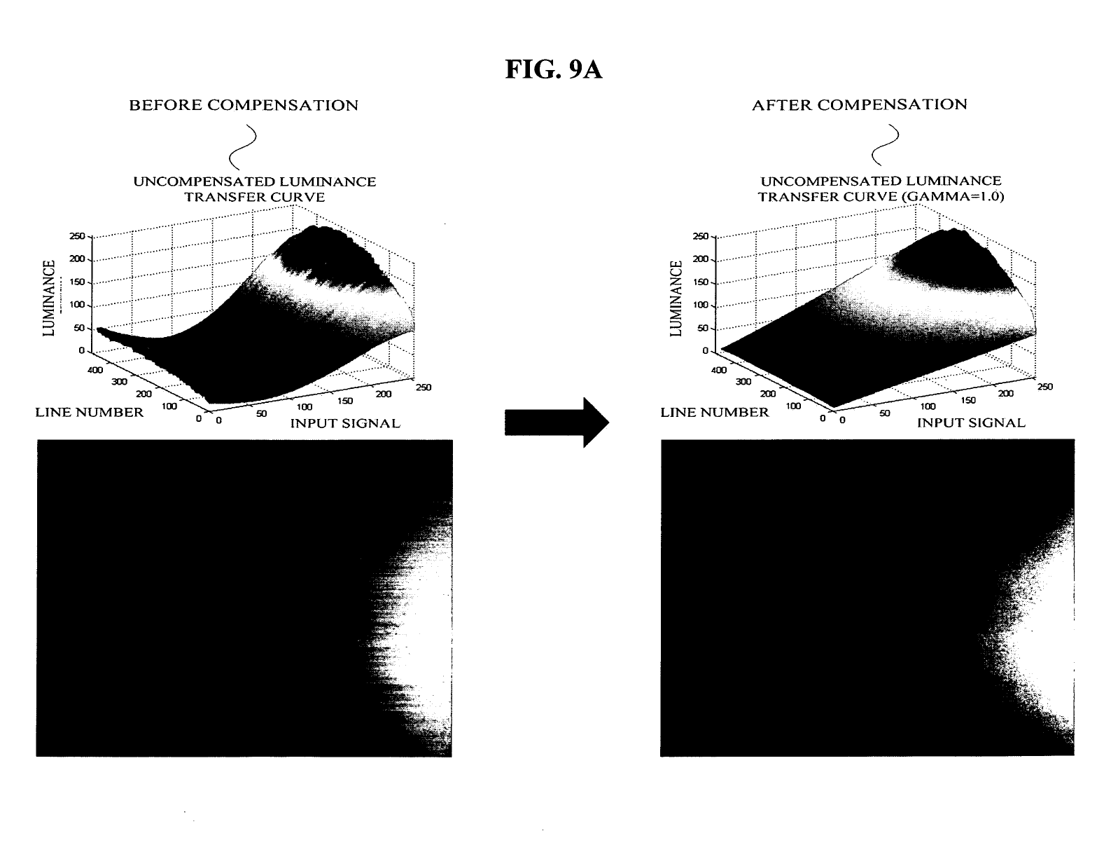

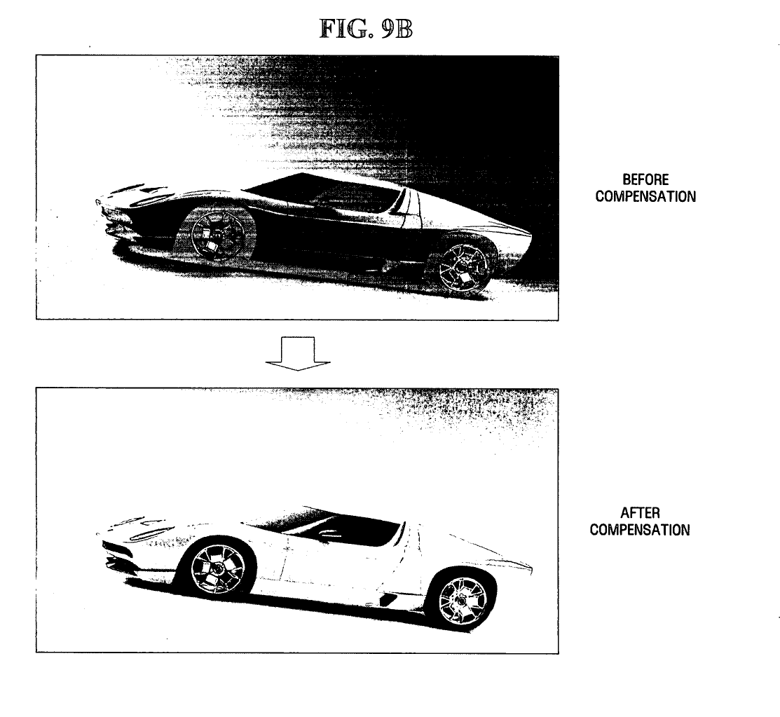

The result of the compensation process will now be described with reference to FIGS. 9A and 9B. FIGS. 9A and 9B are views for comparing an output image before and after a compensation method according to an embodiment of the present invention is applied. On the left of FIG. 9A, a luminance transfer curve before the compensation process and an output image according to the luminance transfer curve are illustrated. On the right of FIG. 9A, a luminance transfer curve linearly transformed after the compensation process and an output image according to the luminance transfer curve are illustrated. The gray scale output image on the right has significantly reduced line pattern artifacts, which are generated in a horizontal direction. Such a reduction can be clearly found in FIG. 9B, showing a color image before and after being compensated.

The embodiments of the present invention may be applied to a display apparatus using a 1D optical modulator such as a mobile projector, a mini projector, and a projection TV.

According to an embodiment of the present invention, an input signal is preprocessed and compensated before being input to an optical modulator. Therefore, line pattern artifacts can be reduced, which, in turn, enhances image quality.

The term ‘unit’, as used for components illustrated in FIG. 4, may mean, but is not limited to, a software or hardware component, such as a Field Programmable Gate Array (FPGA) or Application Specific Integrated Circuit (ASIC), which performs certain tasks. A unit may advantageously be configured to reside on the addressable storage medium and configured to execute on one or more processors. Thus, a unit may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and units may be combined into fewer components and units or further separated into additional components and units. In addition, the components and units may be implemented to execute one or more central processing units (CPUs) in a device.

It is apparent to those of ordinary skill in the art that the embodiments of the present invention can also be implemented as computer-readable code on a computer-readable recording medium.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A method of compensating for an alignment mismatch of an optical modulator, the method comprising:
performing gamma correction on an input signal having M gradation levels and outputting a preprocessed signal according to the gamma correction;
performing a linearization transform on the preprocessed signal;
performing a uniformity transform on the linearly transformed signal to limit a region of the linearly transformed signal;
outputting a compensated signal;
receiving the output compensated signal using the optical modulator; and
outputting a compensated luminance value according to the received signal.

2. The method of claim 1, wherein the performing of the gamma correction and the outputting of the preprocessed signal comprises performing an inverse transform of the linearization transform on the gamma-corrected signal and outputting the preprocessed signal.

3. The method of claim 2, wherein the performing of the gamma correction and the outputting of the preprocessed signal comprises, if the input signal is p and the preprocessed signal is p,′ defining the relationship between p and p′ as
p′=f_{R}⁻¹∘Γ(p)
and storing the relationship between p and p′ in the form of an M×1 lookup table, wherein f_{R}⁻¹ indicates the inverse transform of the linearization transform and [[γ(p)]]┌(p) indicates a gamma correction function.

4. The method of claim 1, wherein the performing of the linearization transform and the uniformity transform and the outputting of the compensated signal comprises performing an inverse transform of a luminance transfer transform on the uniformity transformed signal and outputting the compensated signal.

5. The method of claim 4, wherein the performing of the linearization transform and the uniformity transform and the outputting of the compensated signal comprises, if the preprocessed signal is p′ and the output compensated signal is q, defining the relationship between p′ and q as
q=f_{Y,i}⁻¹∘T_{Y,i}∘f_{R}(p′),
where f_{Y,i}⁻¹ indicates the inverse transform of the luminance transfer transform, T_{Y,i} indicates the uniformity transform, f_{R} indicates the linearization transform, and i indicates a line index in a luminance transform curve, the line index corresponding to a number of pixels of vertical resolution of the input signal.

6. The method of claim 5, wherein the performing of the linearization transform and the uniformity transform and the outputting of the compensated signal further comprises storing the relationship between p′ and q in the form of an N×P lookup table, where N indicates a total number of lines in the luminance transform curve and P indicates a number of parameters for the compensated signal.

7. The method of claim 5, wherein the performing of the linearization transform and the uniformity transform and the outputting of the compensated signal further comprises linearly approximating the relationship between p′ and q using
q=C_{0,i}(p′)+C_{1,i}(p′)·p′,
where C_{0,i} and C_{1,i} indicate linear approximation parameters.

8. The method of claim 5, wherein the performing of the uniformity transform comprises limiting an entire input gradation region having a gradation range of 0 to M of each line having an S shape in the luminance transform curve to a gradation region in which each of the lines increases linearly.

9. The method of claim 8, wherein the performing of the uniformity transform further comprises performing a fitting process on the luminance transform curve comprising assigning a predetermined offset to each of a maximum luminance value and a minimum luminance value on a two-dimensional (2D) plane whose horizontal axis indicates an index of each line having a limited gradation region and a vertical axis indicates a luminance value for the index of each of the lines having the limited gradation region.

10. The method of claim 5, wherein the receiving of the output compensated signal and the outputting of the compensated luminance value comprise performing the luminance transfer transform f_{Y,i} on the output compensated signal q and outputting the compensated luminance value.

11. An apparatus for compensating for an alignment mismatch of an optical modulator, the apparatus comprising:
a preprocessed signal output unit performing gamma correction on an input signal having M gradation levels and outputting a preprocessed signal according to the gamma correction;
a compensated signal output unit performing a linearization transform on the preprocessed signal, performing a uniformity transform on the linearly transformed signal to limit a region of the linearly transformed signal, and outputting a compensated signal; and
a luminance value output unit receiving the output compensated signal using the optical modulator and outputting a compensated luminance value according to the received signal.

12. The apparatus of claim 11, wherein the preprocessed signal output unit performs an inverse transform of the linearization transform on the gamma-corrected signal and outputs the preprocessed signal.

13. The apparatus of claim 12, wherein the preprocessed signal output unit, if the input signal is p and the preprocessed signal is p,′ defines the relationship between p and p′ as
p′=f_{R}⁻¹∘Γ(p)
and stores the relationship between p and p′ in the form of an M×1 lookup table, wherein f_{R}⁻¹ indicates the inverse transform of the linearization transform and ┌(p) indicates a gamma correction function.

14. The apparatus of claim 11, wherein the compensated signal output unit performs an inverse transform of a luminance transfer transform on the uniformity transformed signal and outputs the compensated signal.

15. The apparatus of claim 14, wherein the compensated signal output unit, if the preprocessed signal is p′ and the output compensated signal is q, defines the relationship between p′ and q as
q=f_{Y,i}⁻¹∘T_{Y,i}∘f_{R}(p′),
where f_{Y,i}⁻¹ indicates the inverse transform of the luminance transfer transform, T_{Y,i} indicates the uniformity transform, f_{R} indicates the linearization transform, and i indicates a line index in a luminance transform curve, the line index corresponding to a number of pixels of vertical resolution of the input signal.

16. The apparatus of claim 15, wherein the compensated signal output unit stores the relationship between p′ and q in the form of an N×P lookup table, where N indicates a total number of lines in the luminance transform curve and P indicates a number of parameters for the compensated signal.

17. The apparatus of claim 15, wherein the compensated signal output unit linearly approximates the relationship between p′ and q using
q=C_{0,i}(p′)′C_{1,i}(p′)·p′,
where C_{0,i} and C_{1,i} indicate linear approximation parameters.

18. The apparatus of claim 15, wherein the uniformity transform limits an entire input gradation region having a gradation range of 0 to M of each line having an S shape in the luminance transform curve to a gradation region in which each line increases linearly.

19. The apparatus of claim 18, wherein the uniformity transform comprises performing a fitting process on the luminance transform curve comprising assigning a predetermined offset to each of a maximum luminance value and a minimum luminance value on a two-dimensional (2D) plane whose horizontal axis indicates an index of each line having a limited gradation region and a vertical axis indicates a luminance value for the index of each line having the limited gradation region.

20. The apparatus of claim 15, wherein the luminance value output unit performs the luminance transfer transform f_{Y,i} on the output compensated signal q and outputs the compensated luminance value.

21. A computer-readable recording medium being recorded with a program code for executing the method of any one of claims 1 through 10.

22. The apparatus of claim 11, wherein the optical modulator is a 1D optical modulator.

23. A method comprising:
scanning an image with a 1D optical modulator;
generating a signal in response to the scanning;
preprocessing and compensating the signal; and
inputting the preprocessed and compensated signal to the optical modulator, the preprocessing and compensating being before the inputting.
